(19) United States
(12) Patent Application Publication
(10) Pub. No.: US 2005/0102625 A1
(43) Pub. Date: May 12, 2005

(54) Audio tag retrieval system and method

(76) Inventors: Yong C. Lee, Miramar, FL (US); Charles D. Estes, Fort Lauderdale, FL (US); Jyh-Han Lin, Coral Springs, FL (US)

Correspondence Address: AKERMAN SENTERFITT, P.O. BOX 3188, WEST PALM BEACH, FL, 33402-3188, US

(21) Appl. No.: 10/703,775

(22) Filed: Nov. 7, 2003

(51) Int. Cl. G06F 3/00

(52) U.S. Cl. 715/727

(57) ABSTRACT

A audio tag retrieval system and method (50) includes a communication device (70) capable of retrieving an audio tag having a transceiver (38,44), a display (30) coupled to the transceiver and having a graphical user interface (28), and a processor (12) coupled to the transceiver and display. The processor can be programmed to retrieve (64) an audio tag representative of an element within the communication device responsive to a selection of the element on the graphical user interface of the communication device and to download (66) the audio tag from a remote server if the audio tag representative of the element is not found within the communication device.

### CROSS-REFERENCE TO RELATED APPLICATIONS

Not applicable.

### FIELD OF THE INVENTION

This invention relates in general to audio tags and voice tags, and more particularly to retrieving such tags locally or from a remote server.

### BACKGROUND OF THE INVENTION

More and more users are using hand-held devices such as cellular phones, personal digital assistants, Smart Phones and other devices as their main source of communicating and organizing. As a main source of communicating, many users use these devices to read emails, send SMS messages, read news, and otherwise communicate while they are in transit or out of their traditional offices. For example, many users use these devices in the airport, while riding cabs, trains or buses. Most legacy devices only display text, and this is the main way of communicating between the user and the device. While these handheld devices proliferate, existing communication between the device and user using only a display in many scenarios proves to be inadequate and fails to assist users with reading the contents that are being displayed on the screen.

### SUMMARY OF THE INVENTION

Embodiments in accordance with the invention illustrate systems and methods of reading any strings or contents that are on a screen without having to look at the screen to read the contents. Instead, such embodiments will read the contents on the screen for the user. In addition, audio or voice tags can be downloaded from a central server for any symbol or new strings or even to support international users. In other words, as long as a device can display a string in any language, a particular embodiment in accordance with the invention will read the string, and if such a voice tag is not available, the device shall download the new voice tag from a server.

In a first embodiment in accordance with the invention, a method of retrieving an audio tag for a communication device can include the steps of retrieving an audio tag representative of an element within the communication device responsive to the selection of the element on a graphical user interface of the communication device and downloading the audio tag from a remote server if the audio tag representative of the element is not found within the communication device. The method can also include the steps of identifying the audio tag representative of the element selected and generating an audio output representative of the audio tag.

In a second embodiment, a communication device capable of retrieving an audio tag can include a transceiver, a display coupled to the transceiver having a graphical user interface, and a processor. The processor can be programmed to retrieve an audio tag representative of an element within the communication device responsive to a selection of the element on the graphical user interface of the communication device and download the audio tag from a remote server if the audio tag representative of the element is not found within the communication device. The processor can be further programmed to identify the audio tag representative of the element selected, to enter a narrator mode and to generate an audio output representative of the audio tag. The communication device can be any number of devices including, but not limited to a cellular phone, a smart phone, a personal digital assistant, a laptop computer, a two-way pager, a mobile radio, a household appliance, and an industrial appliance.

In a third embodiment of the present invention, a communication device capable of retrieving an audio tag can include a transceiver, means for selecting an element on a graphical user interface of the communication device, means for retrieving an audio tag representative of the element within the communication device, and means for downloading the audio tag from a remote server if the audio tag representative of the element is not found within the communication device. The communication device can also include a means for identifying the audio tag representative of the element selected.

In another embodiment, a computer program can have a plurality of code sections executable by a machine for causing the machine to retrieve an audio tag representative of an element within the machine responsive to a selection of the element on a graphical user interface of the machine and to download the audio tag from a remote server if the audio tag representative of the element is not found within the machine.

### BRIEF DESCRIPTION OF THE DRAWINGS

FIG. 1 illustrates a block diagram of a communication device capable of retrieving an audio tag in accordance with the present invention.

FIG. 2 illustrates a flow chart of a method of retrieving an audio tag in accordance with the present invention.

FIG. 3 is an illustration of a phone annunciating text in a narrator mode in accordance with the present invention.

FIG. 4 is an illustration of a phone annunciating a symbol or other content in a narrator mode in accordance with the present invention

### DETAILED DESCRIPTION OF THE DRAWINGS

While the specification concludes with claims defining the features of the invention that are regarded as novel, it is believed that the invention will be better understood from a consideration of the following description in conjunction with the drawing figures, in which like reference numerals are carried forward.

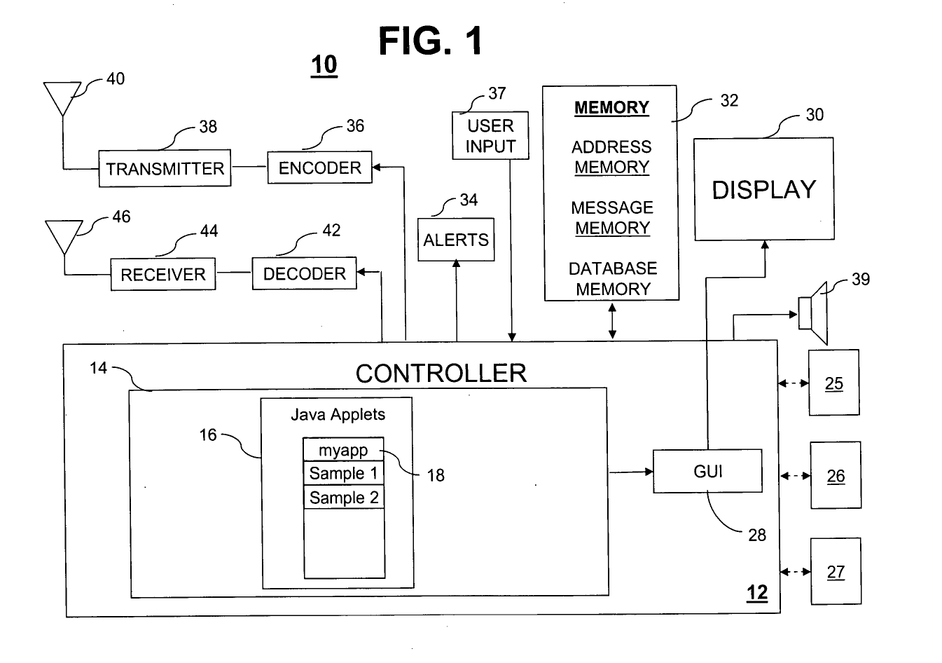

Referring to FIG. 1, a block diagram of a portable communication device 10 can comprise a conventional cellular phone, a two-way trunked radio, a combination cellular phone and personal digital assistant, a smart phone, a home cordless phone, a satellite phone or even a wired phone having a display and an ability to retrieve audio or voice tags in accordance with the present invention. In this particular embodiment, the portable communication device 10 can include an encoder 36, transmitter 38 and antenna 40 for encoding and transmitting information as well as an antenna 46, receiver 44 and decoder 42 for receiving and decoding information sent to the portable communication device 10. The device 10 can further include an alert 34, memory 32, a user input device 37 (such as a keyboard, mouse, voice recognition program, etc.), a speaker or annunciator 39, and a display 30 for at least displaying a graphical user interface (GUI) 28 as will be further detailed below. The device 10 can further include a processor or controller 12 coupled to the display 30, the encoder 36, the decoder 42, the alert 34, the user input 37 and the memory 32. The memory 32 can include address memory, message memory, and memory for database information or for voice or audio tags. The audio or voice tags which can be in “.wav? format can reside in external memory (32) or in internal memory 16 within a portion 14 of the processor 12 as shown. The memory (either 32 or 16) can include a database or one or more look-up tables that can correlate a selected portion of content from the GUI 28 with one or more audio or voice tags. In this embodiment, when content corresponding to the Java Applet “myApp” is selected on the GUI, the “myApp.wav” file will be played. Audio or voice tags of multiple languages can also be handled by the device 10 without necessarily requiring separate language engines for each language when using a device or method in accordance with an embodiment of the invention. For example, if the phone is set in a Korean language mode, it will play a “myApp-korean.wav” file if locally available. If not locally available, the communication device 10 can retrieve the audio or voice tag and download it from one or more remote servers 25, 26, and 27. If an Applet or J2ME MIDlet is used as described below in an example of a JAD file for “myApp”, then the new audio or voice tag can be retrieved from the address http://www.myApp.com/newVoiceTag/. In an exemplary embodiment, the application used as the means for retrieving audio or voice tags can be a Java-based application although other language-based applications are contemplated within the scope of the present invention.

An example using a J2ME MIDlet is shown below:
JAD file of myApp MIDlet:
MIDlet-Name: myApp
MIDlet-1: myApp, myApp.png, com.Motorola.myApp
MIDlet-Jar-Size: 3128
MIDlet-Jar-URL: myAppjar
MIDlet-Vendor: Motorola Inc.
MIDlet-Version: 1.0
iDEN-MIDlet-Voice-Name: myApp.wav
iDEN-MIDlet-Voice-Name-kr: myApp-korean.wav
iDEN-MIDlet-Voice-Name-url: http://www.mvApp.com/newVoiceTag/

Note that myApp.wav and myApp-korean.wav will be included in the myAppjar as a resource.

The Java™ Archive (JAR) file format used above provides the ability to bundle multiple files into a single archive file. Typically a JAR file will contain the class files and auxiliary resources associated with applets and applications. A JAR file can contain Java classes for each MIDlet in a suite, Java classes shared between MIDlets, resource files used by the MIDlets (for example, image files), and a manifest file describing the JAR contents and specifying attributes used by application management software to identify and install the MIDlet suite.

A Java Application Descriptor (JAD) file can contain a predefined set of attributes (denoted by names that begin with “MIDlet-”) that allow application management software to identify, retrieve, and install the MIDlets. All attributes appearing in the JAD file are made available to the MIDlets. A user can define his or her own application-specific attributes and add them to the JAD file.

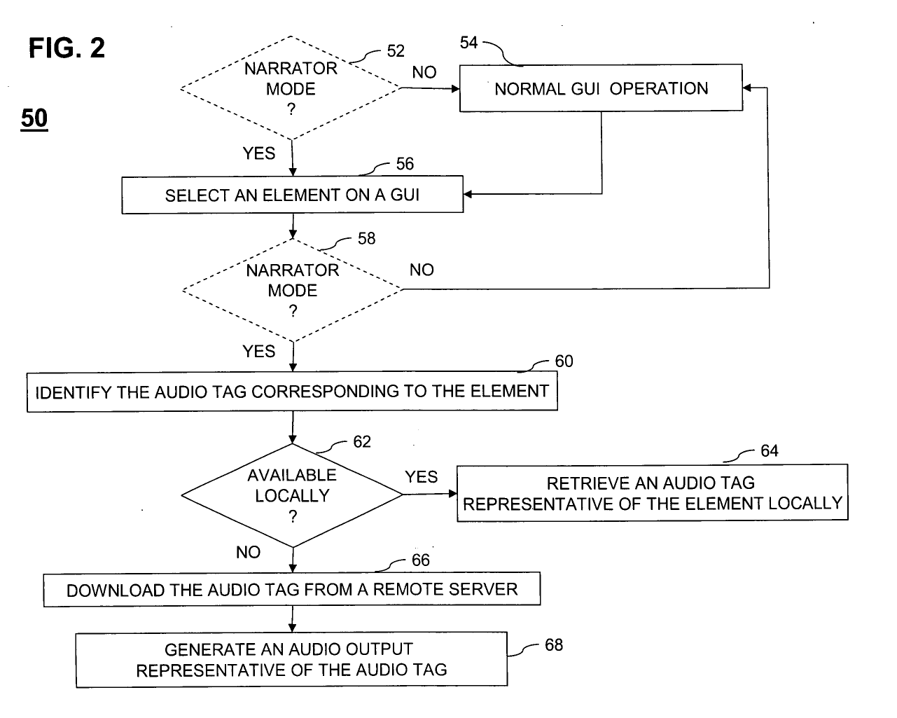

Referring to FIG. 2, a flow chart illustrating a method 50 of retrieving an audio or voice tag in accordance with an embodiment of the present invention is shown. The method 50 can include a determination of whether a device is in a narrator mode at optional decision block 52. If the device is not in a narrator mode at decision block 52, then the GUI will operate normally at step 54. Whether the device is in a narrator mode at decision block 52 or not, the method can then include the step of selecting an element on a GUI at step 56. Once again, the method can include an optional determination after the selection of the element whether the device is in a narrator mode at decision block 58. If the device is already in a narrator mode from decision block 52, then decision block 58 can be skipped. If the device is not already in a narrator mode or not currently entered into a narrator mode (by a current user selection, for example) at decision block 58, then the device will otherwise function with a normal GUI interface. If the device is in a narrator mode at decision block 58, then the method 50 can optionally identify the audio or voice tag corresponding to the selected element at step 60. At decision block 62, a determination can be made whether the audio or voice tag is available locally within the device or a storage device immediately coupled to the device. If available locally, the audio tag representative of an element is retrieved locally at step 64. If not available locally at decision block 62, then the audio or voice tag can be downloaded from a remote server at step 66. Once retrieved, an audio output representative of the audio or voice tag can optionally be generated at step 68.

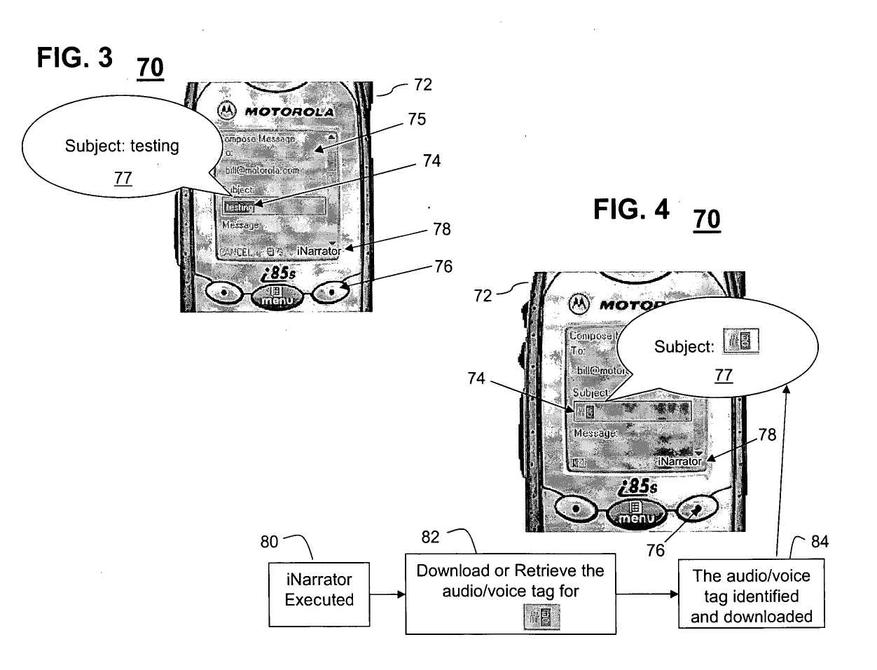

Referring to FIGS. 3 and 4, a communication device 70 such as a portable mobile phone or cellular phone is shown having the capability of retrieving audio tags or voice tags. The communication device 70 can include a display 75 within a housing 72. The communication device can include a GUI on the display having a plurality of selectable elements such as selected element 74. The communication device 70 can further include one or more input selection devices such as keypad 76. For example, when keypad 76 is depressed during a predetermined menu or sub-menu of the GUI, the device can enter a narrator mode as indicated by indicator 78 designated as “iNarrator” in this embodiment. As shown in the flow diagram associated with FIG. 4, when the narrator mode is executed at step 80, the device 70 is directed to retrieve or download an audio or voice tag for the selected content in the GUI at step 82. Once the audio or voice tag is identified and downloaded at step 84, the audio or voice tag file can be played or annunciated via a speaker as indicated by speech bubble 77. Note that in FIG. 3, the audio or voice tag can correspond to text such as the word “testing”. Alternatively, the audio or voice tag can correspond to any type of content such as symbols or icons as shown in FIG. 4.

In light of the foregoing description of the invention, it should be recognized that the present invention can be realized in hardware, software, or a combination of hardware and software. A method and system for retrieving an audio or voice tag according to an embodiment of the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the methods described herein, is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which, when loaded in a computer system, is able to carry out these methods. A computer program or application in the present context means any expression, in any language, code or notation, of a set of instructions intended to cause a system having an information processing capability to perform a particular function either directly or after either or both of the following a) conversion to another language, code or notation; b) reproduction in a different material form.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method of retrieving an audio tag for a communication device, comprising the steps of:
retrieving an audio tag representative of an element within the communication device responsive to the selection of the element on a graphical user interface of the communication device; and
downloading the audio tag from a remote server if the audio tag representative of the element is not found within the communication device.

2. The method of claim 1, wherein the method further comprises the step of generating an audio output representative of the audio tag.

3. The method of claim 1, wherein the method further comprises entering a narrator mode before the selection of the element.

4. The method of claim 1, wherein the method further comprises entering a narrator mode after the selection of the element.

5. The method of claim 1, wherein the method further comprises the step of identifying the audio tag representative of the element selected.

6. A communication device capable of retrieving an audio tag, comprises:
a transceiver;
a display coupled to the transceiver and having a graphical user interface; and
a processor coupled to the transceiver and display, wherein the processor is programmed to:
retrieve an audio tag representative of an element within the communication device responsive to a selection of the element on the graphical user interface of the communication device; and
download the audio tag from a remote server if the audio tag representative of the element is not found within the communication device.

7. The communication device of claim 6, wherein the processor is further programmed to generate an audio output representative of the audio tag.

8. The communication device of claim 6, wherein the communication further comprises a narrator function that is user activated.

9. The communication device of claim 6, wherein the processor is further programmed to enter a narrator mode before selection of the element.

10. The communication device of claim 6, wherein the processor is further programmed to enter a narrator mode after selection of the element.

11. The communication device of claim 6, wherein the communication device is selected from the group comprising a cellular phone, a smart phone, a personal digital assistant, a laptop computer, a two-way pager, a mobile radio, a household appliance, and an industrial appliance.

12. The communication device of claim 6, wherein the processor is further programmed to process audio tags of multiple languages without requiring multiple language engines.

13. The communication device of claim 6, wherein the processor downloads the audio tag from the remote server via a wireless connection to the internet.

14. A communication device capable of retrieving an audio tag, comprises:
a transceiver;
means for selecting an element on a graphical user interface of the communication device;
means for retrieving an audio tag representative of the element within the communication device; and
means for downloading the audio tag from a remote server if the audio tag representative of the element is not found within the communication device.

15. The communication device of claim 14, wherein the communication further comprises a narrator function that is user activated and enables the means for retrieving and the means for downloading the audio tag.

16. The communication device of claim 14, wherein the communication device is selected from the group comprising a cellular phone, a smartphone, a personal digital assistant, a laptop computer, a two-way pager, a mobile radio, a household appliance, and an industrial appliance.

17. The communication device of claim 14, wherein the communication device further comprises a means for identifying the audio tag representative of the element selected.

18. The communication device of claim 14, wherein the means for downloading the audio tag from the remote server is a wireless connection to the internet.

19. The communication device of claim 14, wherein the means for selecting is selected among the group comprising a keypad, a keyboard, a touch screen, a voice recognizer, a joystick, and a mouse.

20. A machine readable storage, having stored thereon a computer program having a plurality of code sections executable by a machine for causing the machine to perform the steps of:
retrieve an audio tag representative of an element within the machine responsive to a selection of the element on a graphical user interface of the machine; and
download the audio tag from a remote server if the audio tag representative of the element is not found within the machine.
